(19) United States
(12) Patent Application Publication
(10) Pub. No.: US 2013/0110600 A1
(43) Pub. Date: May 2, 2013

(54) MOBILE DATA SERVICE PLATFORM, SYSTEM AND METHOD FOR PROVIDING VALUE-ADDED SERVICES

(71) Applicant: Huawei Technologies Co., Ltd., Shenzhen (CN)

(72) Inventor: Yan Lu, Shenzhen (CN)

(73) Assignee: Huawei Technologies Co., Ltd., Shenzhen (CN)

(21) Appl. No.: 13/725,261

(22) Filed: Dec. 21, 2012

Related U.S. Application Data
(63) Continuation of application No. PCT/CN2011/073332, filed on Apr. 26, 2011.

(30) Foreign Application Priority Data
Jun. 23, 2010 (CN) 201010213879.X

(51) Int. Cl. G06Q 30/02

(52) U.S. Cl. CPC G06Q 30/0214
USPC 705/14.16

(57) ABSTRACT

A mobile data service platform, system and method for providing value-added services are disclosed. The method includes: firstly, receiving service information parameters of recommendation or gift transmitted by an operator portal (Portal), establishing the recommendation or gift relationship according to the parameters, and informing receiving users of the recommendation or gift; secondly, receiving the charging request transmitted by a service server after the service server receiving a service request of the recommendation or gift initiated by the receiving user; thirdly, charging the recommendation or gift service initiated by the receiving user according to the credit status of the paying user; finally, updating, according to the established relationship of the recommendation or gift, the credit value of the initiating user after completing the charging.

### CROSS-REFERENCE TO RELATED APPLICATIONS

This application is a continuation of International Application No. PCT/CN2011/073332, filed on Apr. 26, 2011, which claims priority to Chinese Patent Application No. 201010213879.X, filed on Jun. 23, 2010, both of which are hereby incorporated by reference in their entireties.

### FIELD OF THE INVENTION

The present invention relates to mobile communication technology, and more specifically, to a mobile data service platform, system and method for providing value-added services.

### BACKGROUND OF THE INVENTION

According to current methods of providing value-added services, initiating users always recommend service information to receiving users or provide the service information as a gift to the receiving users in ways accessible by the receiving users, while mobile data service platforms or carrier portals know nothing about such a recommendation or gift relationship. Initiating users are rewarded only when receiving user make use of such service information through inputting information of initiating users and passing verification according to prompts of mobile data service platforms or carrier portals.

During the plan of this invention, the inventors have identified at least the following issues in the prior art.

If initiating users cannot be verified accurately by mobile data service platforms or carrier portals, receiving users cannot be guaranteed as those ones recommendation by the initiating users. Besides, before the use of the service information, receiving users have to, firstly, enter information of initiating users, which may impact experience of receiving users.

### SUMMARY OF THE INVENTION

A mobile data service platform, system and method for providing value-added services are provided in embodiments of this invention, in which the process of entering information of initiating users of recommendation and gift before using service information by receiving users is omitted, resulting in a more accurate recommendation or gift relationship, enabling real-time updating of user credit values, which is convenient for initiating users and can improve user experience of the receiving user at the same time.

A method for providing value-added services is provided in an embodiment of this invention, comprising:

receiving recommendation or gift service information parameter transmitted by a carrier portal, establishing a recommendation or gift relationship according to the recommendation or gift service information parameter and notifying it to a receiving user of the recommendation or gift;

receiving a charging request sent by a service server after receiving a request of the recommendation or gift service of the receiving user;

according to the credit of a paying user, charging for the recommendation or gift service initiated by the receiving user;

after successful charging, according to the recommendation or gift relationship, updating the credit of the initiating user.

A mobile data service platform for providing value-added services is provided in an embodiment of this invention, comprising:

a receiving module for receiving a recommendation or gift service information parameter transmitted from a carrier portal,

an establishing module for establishing a recommendation or gift relationship according to the recommendation or gift service information parameter received by the receiving module and notifying it to a receiving user of the recommendation or gift; wherein,

the receiving module is further adapted to receive a charging request sent by a service server after receiving a request of the recommendation or gift service of the receiving user;

a charging module for according to credit of a paying user, charging for the recommendation or gift service initiated by the receiving user;

an updating module for after successful charging, according to the recommendation or gift relationship, updating the credit of the initiating user.

A method for providing value-added services is provided in an embodiment of this invention, comprising:

presenting service information to users by a carrier portal, and sending a recommendation or gift service information parameter to a mobile data service platform, the recommendation or gift service information parameter comprising initiating user information, receiving user information, and a recommendation or gift service information ID;

establishing a recommendation or gift relationship by the mobile data service platform according to the received recommendation or gift service information parameter;

sending a charging request to the mobile data service platform by a service server after receiving a request of the recommendation or gift service of the receiving user;

after receiving the charging request sent by the service server, determining by the mobile data service platform whether a paying user has enough credit to pay a number required by the recommendation or gift service initiated by the receiving user, if enough, deducting the corresponding number from the credit of the paying user, otherwise sending a payment deduction request to a payment deducting device, which after receiving the payment deduction request and deducting a payment from the paying user, returns a payment deduction response to the mobile data service platform; updating the credit of the initiating user after deducting the corresponding number from the credit of the paying user or receiving the payment deduction response information sent by the payment deducting device, and notifying the successful payment to the service server;

after receiving the notification of the mobile data service platform, providing the recommendation or gift service for the receiving user by the service server.

A system for providing value-added services is provided in an embodiment of this invention, comprising a mobile data service platform, a carrier portal, a service server and a payment deducting device, wherein,

the portal is adapted to present service information to users, and send a recommendation or gift service information parameter to a mobile data service platform, the recommendation or gift service information parameter comprising initiating user information, receiving user information, and a recommendation or gift service information ID;

the mobile data service platform is adapted to establish a recommendation or gift relationship according to the received recommendation or gift service information parameter sent from the portal; after receiving the charging request sent by the service server, determine whether a paying user has enough credit to pay a number required by the recommendation or gift service initiated by the receiving user, if enough, deduct the corresponding number from the credit of the paying user, otherwise send a payment deduction request to a payment deducting device; update the credit of an initiating user after deducting the corresponding number from the credit of the paying user or receiving the payment deduction response information sent by the payment deducting device, and notify the successful payment to the service server;

the payment deducting device is adapted to receive the payment deduction request, and return a payment deduction response to the mobile data service platform after deducting a payment from the paying user;

the service server is adapted to send a charging request to the mobile data service platform after receiving a request of the recommendation or gift service of the receiving user, and provide the recommendation or gift service for the receiving user after receiving the notification of the mobile data service platform.

It can be seen from the technical solutions provided in embodiments of this invention, an initiating user recommends or provides service information as a gift to a receiving user through a carrier portal and a mobile data service platform, and the process of entering information of initiating users of recommendation and gift before using service information by receiving users is omitted, enabling more accurate recommendation or gift relationship and real-time updating of user credit values, which is convenient for initiating users and can improve user experience.

### BRIEF DESCRIPTION OF THE DRAWINGS

For a more explicit description of the technical solutions of embodiments of this invention, a brief introduction of accompanying drawings to be used in the description of these embodiments will be given below. Obviously, accompanying drawings described below are merely some embodiments of this invention, for those skilled in the art, other accompanying drawings can be derived from these ones without any creative efforts.

FIG. 1 is a schematic flowchart of a method for providing value-added services of an embodiment of this invention;

FIG. 2 is a schematic structural diagram of a mobile data service platform for providing value-added services of an embodiment of this invention;

FIG. 3 is a schematic structural diagram of a system for providing value-added services of an embodiment of this invention;

FIG. 4 is another schematic flowchart of a method for providing value-added services of an embodiment of this invention;

FIG. 5 is a schematic flowchart of an example of an embodiment of this invention, in which initiating user A recommends a multimedia message service (MMS) to receiving user B.

### DETAILED DESCRIPTION OF THE PREFERRED EMBODIMENT

A clear, complete description will be given to technical solutions of embodiments of this invention in connection with accompanying drawings of embodiments of this invention. Obviously, embodiments described herein are merely some embodiments of this invention, but not all of them. Based on those embodiments of this invention, other embodiments can occur to those skilled in the art without any creative efforts, all of which fall within the scope of this invention.

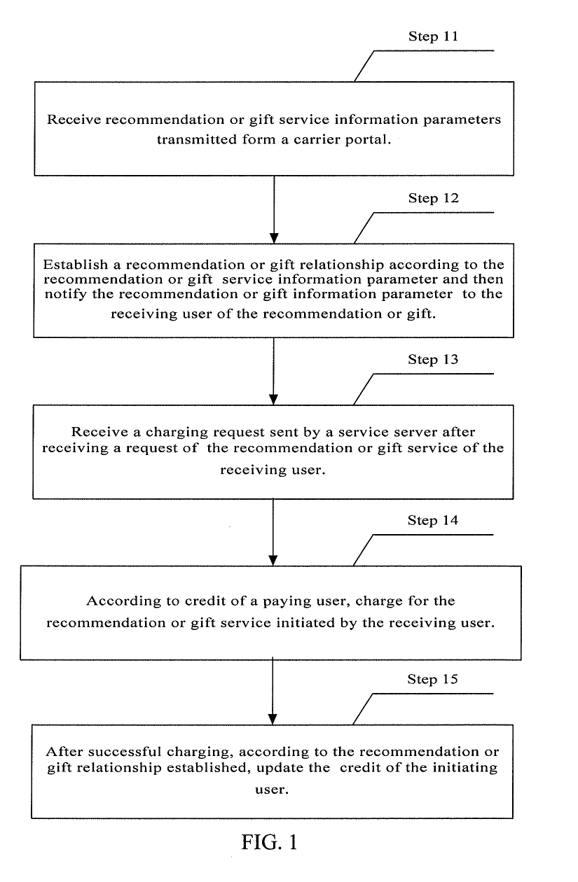

A method for providing value-added services is provided in an embodiment of this invention, as shown in FIG. 1 comprising the following steps.

Step 11. Receive recommendation or gift service information parameter transmitted from a carrier portal.

Particularly, the carrier portal may be a commercial website or an official website of a carrier, which is a portal system for providing telecommunication services for end users or providing business acceptance for carrier operators. The portal is mainly in the form of WEB, WAP, SMS, IVP. The recommendation or gift service information parameter may comprise initiating user information, receiving user information, a recommendation or gift service information ID, payment manner information and/or the number of receiving users, etc.

Step 12. Establish a recommendation or gift relationship according to the recommendation or gift service information parameter as received and then notify it to the receiving user of the recommendation or gift.

Further, the initiating user can be notified also, particularly, the notification may comprise service information recommendation or provided as a gift by the initiating user. For example, if a MMS (multimedia message service) is recommendation or provided as a gift by the initiating user, the notification may comprise information of the user initiating the recommendation or gift, information of a receiving user, and introduction information of the MMS, etc.

Step 13. Receive a charging request sent by a service server after receiving a request of the recommendation or gift service of the receiving user.

Particularly, if the receiving user confirms to purchase or accept the recommendation or gift service, a request for the recommendation or gift service is initiated on a service server. After receiving the service request, the service server sends a charging request to a mobile data service platform, which may be a service enabler, such as SMSC (Short message Service Center), MMSC (Relay server/Multimedia Message Service Center), WAP or GW, etc.

Step 14. According to the credit of a paying user, charge for the recommendation or gift service initiated by the receiving user.

Particularly, the paying user may be the receiving user or the initiating user. If a service is recommendation by the initiating user, the paying user is the receiving user; if the service is provided as a gift to the receiving user by the initiating user, the paying user is the initiating user. The mobile data service platform charges after receiving the charging request sent by the service server correspondingly.

Further, the charging process may comprise:

determining whether the paying user has enough credit to pay a number required by the recommendation or gift service, if enough, deducting the corresponding number from the credit of the paying user (the process of credit deducting is carried out in the mobile data service platform), otherwise, keeping the credit of the paying user unchanged and charging a corresponding amount from an account of the paying user (the mobile data service platform sends a payment deduction request to a payment deducting device, and the payment deducting device deducts the corresponding payment from the account, and returns a payment deduction response to the mobile data service platform).

The paying user can select from different payment manners as wished, for example, select to deduct from his account directly or to pay by credits, or select a default manner, i.e., to pay by credit first, and then if not enough, to deduct from an account of the paying user. For example, if a service information provided as a gift by the initiating user needs 30 credit and is priced at 10 Yuan, while the initiating user actually has only 20 credits, because the actual number of credit of the initiating user is less than 30, the credit of the initiating user is kept unchanged and 10 Yuan is deducted from the account of the paying user to complete this payment.

Step 15. After successful charging, according to the recommendation or gift relationship established, update credit of the initiating user.

Particularly, the service of updating credit of the initiating user may be another service, such as a discounting or redeeming service required by the user. Updating credit of the initiating user may comprise increasing the number of credit for the initiating user, if this is the case, the mobile data service platform can save and accumulate user credits; the number of increased credit is the product of the number of receiving users and a service reward coefficient set up by the carrier, including a recommendation service reward coefficient and a gift service rewarded coefficient, which may or may not be equal with each other, in general, the recommendation service reward coefficient is less than or equals to the gift service rewarded coefficient. The recommendation or gift service reward coefficient can be determined depending on the number of recommendations or gifts, that is, the mobile data service platform can also save or accumulate the number of recommendations or gifts.

Further, before updating credit of the initiating user, the method may further comprise authenticating after receiving the charging request sent from the service server. The authentication process may verify the identification of the receiving user or initiating user in the recommendation or gift relationship, or verify whether the receiving user is eligible for the recommendation or gift service. For example, if the receiving user in the recommendation or gift relationship is a 2G user, and an initiating user has recommendation or provided as a gift a service merely suitable for 3G users to the receiving user, the receiving user is not eligible for the recommendation or gift service.

In the above method, it is also possible to comprise valid date management of credits, after expiring of that date, user credit will be cleared to zero. For example, as to a credit valid date of 2 years, taking a user opening an account on May 2, 2008 as an example, credit of that user may be cleared to zero on May 2, 2010.

Further, the step 15 may be followed by a step 16, in which the service server is notified to provide the recommendation or gift service for the receiving user.

Those skilled in the art may understand that some or all steps of the method of the above described embodiment can be realized with programs and instruction related hardware, the programs can be stored in a computer readable storage medium, such as, a magnetic disk, an optical disc, ROM (Read-Only Memory)/RAM (Random Access Memory), etc, which when executed include steps of the method of the embodiment.

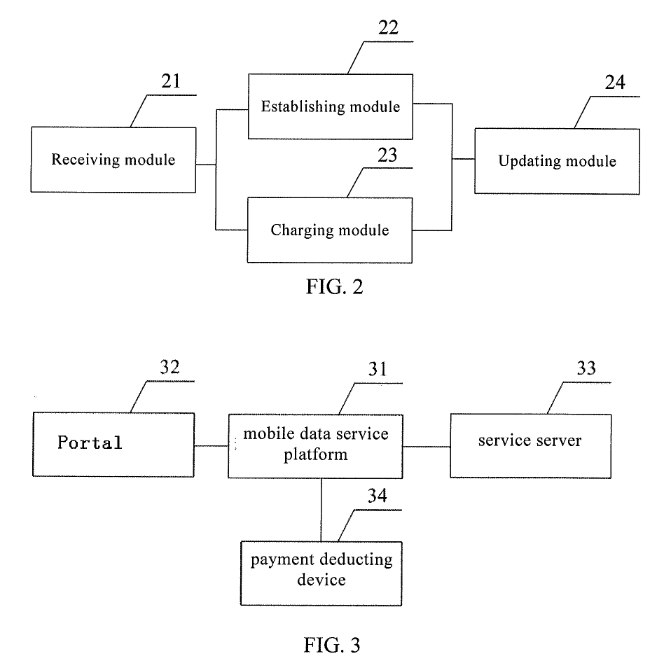

A mobile data service platform for providing value-added services is provided in an embodiment of this invention, as shown in FIG. 2, comprising:

A receiving module 21, for receiving recommendation or gift service information parameter transmitted by a carrier portal;

Particularly, the carrier portal may be a commercial website or an official website of a carrier, which is a portal system for providing telecommunication services for end users or providing business acceptance for carrier operators. The portal mainly takes the form of WEB, WAP, SMS, IVP. The recommendation or gift service information parameter may comprise initiating user information, receiving user information, a recommendation or gift service information ID, payment manner information and/or the number of receiving users, etc.

An establishing module 22, for establishing a recommendation or gift relationship according to the recommendation or gift service information parameter received by the receiving module 21, and notifying it to a receiving user of the recommendation or gift;

Further, the initiating user can be notified also. Particularly, the notification may comprise service information recommendation or provided as a gift by the initiating user. For example, if a MMS (multimedia message service) is recommendation or provided as a gift by the initiating user, the notification may comprise information of the user initiating the recommendation or gift, information of a receiving user, and an introduction of the MMS, etc.

The receiving module 21 is further adapted to receive a charging request sent by a service server after receiving a request of the recommendation or gift service of the receiving user;

Particularly, if the receiving user confirms to purchase or accept the recommendation or gift service, a request for the recommendation or gift service is initiated on a service server. After receiving the service request, the service server sends a charging request to a mobile data service platform, which may be a service enabler, such as SMSC (Short message Service Center), MMSC (Relay server/Multimedia Message Service Center), WAP or GW, etc.

A charging module 23, for according to credit of a paying user, charging for the recommendation or gift service initiated by the receiving user;

Particularly, the paying user may be the receiving user or the initiating user. If a service is recommendation by the initiating user, the paying user is the receiving user; if the service is provided as a gift to the receiving user by the initiating user, the paying user is the initiating user. In both cases, the mobile data service platform charges only after receiving the charging request sent by the service server.

Further, the charging process may comprise:

determining whether the paying user has enough credit to pay a number required by the recommendation or gift service, if enough, deducting the corresponding number from the credit of the paying user (the process of credit deducting is carried out in the mobile data service platform), otherwise, keeping the credit of the paying user untouched and charging a corresponding amount from an account of the paying user (the mobile data service platform sends a payment deduction request to a payment deducting device, and the payment deducting device deducts the corresponding payment from the account, and returns a payment deduction response to the mobile data service platform).

The paying user can select from different payment manners as wished, for example, select to deduct from his account directly or to pay by credits, or select a default manner, i.e., to pay by credit first, and then, if not enough, to deduct from an account of the paying user. For example, if a service information provided as a gift by the initiating user needs 30 credit and is priced at 10 Yuan, while the initiating user actually has only 20 credits, because the actual number of credit of the initiating user is less than 30, the credit of the initiating user is kept unchanged and 10 Yuan is deducted from the account of the paying user to complete this payment.

An updating module 24, for after successful charging, according to the recommendation or gift relationship established by the establishing module 22, updating credit of the initiating user.

Particularly, the service of updating credit of the initiating user herein may be another service, such as a discounting or redeeming service required by the user. Updating credit of the initiating user may comprise increasing the number of credit for the initiating user, and if this is the case, the mobile data service platform can save and accumulate user credits; the number of increased credit is the product of the number of receiving users and a service reward coefficient set up by the carrier, including a recommendation service reward coefficient and a gift service rewarded coefficient, which may or may not be equal with each other, in general, the recommendation service reward coefficient is less than or equals to the gift service rewarded coefficient. The recommendation or gift service reward coefficient can be determined depending on the number of recommendations or gifts, that is, the mobile data service platform can also save or accumulate the number of recommendations or gifts.

Further, an authentication module (not shown in FIG. 2) may be comprised also to authenticate after receiving the authentication request sent from the service server. The authentication process may verify the identification of the receiving user or initiating user in the recommendation or gift relationship, or verify whether the receiving user is eligible for the recommendation or gift service. For example, if the receiving user in the recommendation or gift relationship is a 2G user, and an initiating user has recommendation or provided as a gift a service merely suitable for 3G users to the receiving user, the receiving user is not eligible for the recommendation or gift service.

In the above apparatus, a maintenance module (not shown in FIG. 2) can be further comprised for credit validity maintenance. After expiring of a valid date, user credit will be cleared to zero. For example, as to a credit valid date of 2 years, taking a user opening an account on May 2, 2008 as an example, credit of that user may be cleared to zero on May 2, 2010.

A notification module (not shown in FIG. 2) can be further comprised to notify the service server to provide the recommendation or gift service for the receiving user.

Functions of various modules contained in the above apparatus can be particularly realized as described in the method embodiment above, which will not be repeated herein.

Certainly, the data service platform is not limited to a mobile data service platform, and may be a fixed service platform.

In the embodiment of this invention, an initiating user recommends or provides as a gift service information to a receiving user directly through a mobile data service platform or a carrier portal, and the process of entering information of initiating users of recommendation and gift before using service information by receiving users is omitted, enabling more accurate recommendation or gift relationship and real-time updating of user credits, which is convenient for initiating users and can improve user experience. At the same time, paying by credit is additionally provided without the need of releasing a credit conversion service by the carrier. Therefore, users can decide by themselves to pay for right services without the restriction of credit redeeming for merely services recommendation by carriers, satisfying demands of various kinds of people.

A system for providing value-added services is provided in an embodiment of this invention, as shown in FIG. 3, comprising a mobile data service platform 31, a carrier portal 32, a service server 33 and a payment deducting device 34, connected through interfaces, such as, synchronous interfaces, or an authentication interface, or a payment deduction interface, wherein the payment deducting device 34 is an intelligent network (real-time deduction) or a BOSS (Business and Operation Support System) (non-real-time deduction).

The portal 32 is adapted to present service information to users, and send recommendation or gift service information parameter to the mobile data service platform 31, the recommendation or gift service information parameter comprising initiating user information, receiving user information, a recommendation or gift service information ID, payment manner information and/or the number of receiving users.

The mobile data service platform 31 is adapted to establish a recommendation or gift relationship according to the received recommendation or gift service information parameter sent from the portal; after receiving the charging request sent by the service server 33, determine whether a paying user has enough credit to pay a number required by the recommendation or gift service initiated by the receiving user, if enough, deduct the corresponding number from the credit of the paying user, otherwise send a payment deduction request to the payment deducting device 34; update the credit of an initiating user after deducting the corresponding number from the credit of the paying user or receiving the payment deduction response information sent by the payment deducting device 34, and notify the successful payment to the service server 33;

Particularly, the service of updating credit of the initiating user herein may be another service, such as a discounting or redeeming service required by the user. After receiving the charging request sent from the service server 33, the initiating user or the receiving user can be authenticated at first. The authentication process may verify the identification of the receiving user or initiating user in the recommendation or gift relationship, or verify whether the receiving user is eligible for the recommendation or gift service, if ineligible, no other subsequent determination is needed. For example, if the receiving user in the recommendation or gift relationship is a 2G user, and an initiating user has recommendation or provided as a gift a service merely suitable for 3G users to the receiving user, the receiving user is not eligible for the recommendation or gift service, and is determined as ineligible.

The payment deducting device 34 is adapted to receive the payment deduction request sent by the mobile data service platform 31, and return a payment deduction response to the mobile data service platform 31 after deducting a payment from the paying user.

The service server 33 is adapted to send a charging request to the mobile data service platform 31 after receiving a request of the recommendation or gift service of the receiving user, and provide the recommendation or gift service for the receiving user after receiving the notification of the mobile data service platform 31.

Further the portal 32 can be connected to the mobile data service platform 31 through a credit querying interface. The portal 32 can display in real time or query credit of a signed in user through the interface. The portal is also adapted to provide an input box for initiating users to enter receiving user information.

In the embodiment of this invention, an initiating user recommends or provides as a gift service information to a receiving user directly through a mobile data service platform or a carrier portal, and the process of entering information of initiating users of recommendation and gift before using service information by receiving users is omitted, enabling more accurate recommendation or gift relationship and real-time updating of user credits, which is convenient for initiating users and can improve user experience. At the same time, users can pay on the mobile data service platform by credit or pay from their accounts without the need of releasing a credit redeeming service by the carrier. Therefore, users can decide by themselves to pay for right services without the restriction of credit redeeming for merely services recommendation by carriers, which is convenient for initiating users and can improve user experience. User credits/the number of recommendations or gifts can be saved and accumulated in real time on the mobile data service platform, making the mobile data service platform more powerful consequently.

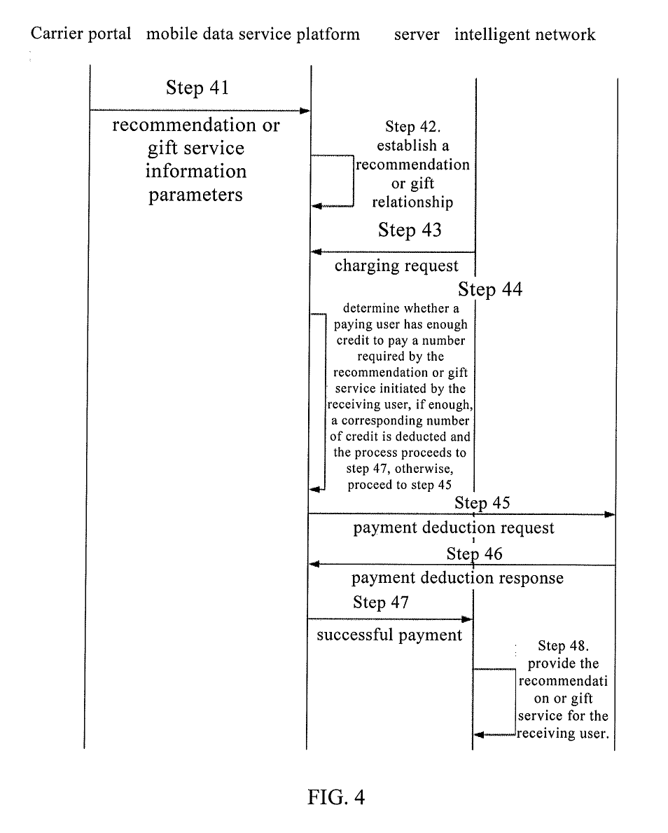

A method for providing value-added services is provided in an embodiment of this invention, as shown in FIG. 4. The particular interactive process comprises the following steps.

Step 41. A portal presents service information to users, and after an initiating user has entered receiving user information and recommendation or gift service information in an input box for receiving user information, sends recommendation or gift service information parameter to a mobile data service platform, the recommendation or gift service information parameter comprising initiating user information, receiving user information, a recommendation or gift service information ID, payment manner information and/or the number of receiving users.

Step 42. The mobile data service platform establishes a recommendation or gift relationship according to the received recommendation or gift service information parameter.

Step 43. A service server sends a charging request to the mobile data service platform after receiving a request of the recommendation or gift service of the receiving user.

Step 44. After receiving the charging request, the mobile data service platform determines whether a paying user has enough credit to pay a number required by the recommendation or gift service initiated by the receiving user, if enough, a corresponding number of credit is deducted and the process proceeds to step 47, otherwise, the process proceeds to step 45.

Further after receiving the charging request sent from the service server 33, the initiating user or the receiving user can be authenticated, wherein the authentication process may verify the identification of the receiving user or initiating user in the recommendation or gift relationship, or verify whether the receiving user is eligible for the recommendation or gift service. If the authentication process fails, then it is not needed to perform the following verifying process. For example, if the receiving user in the recommendation or gift relationship is a 2G user, and an initiating user has recommendation or provided as a gift a service merely suitable for 3G users to the receiving user, the receiving user is not eligible for the recommendation or gift service, and is determined as ineligible.

Step 45. A payment deduction request is sent to a payment deducting device.

Step 46. After deducting a payment of the initiating user or receiving user in the recommendation or gift relationship, the payment deducting device returns a payment deduction response to the service server.

Step 47. The service server updates credit of the initiating user in the recommendation or gift relationship and notifies the successful payment to the service server.

Step 48. After receiving the notification, the recommendation or gift service is provided for the receiving user.

In the above method, the portal displays in real time or queries credit of a signed in user through the credit query interface, and provide an input box for the initiating user in the recommendation or gift relationship to enter receiving user information.

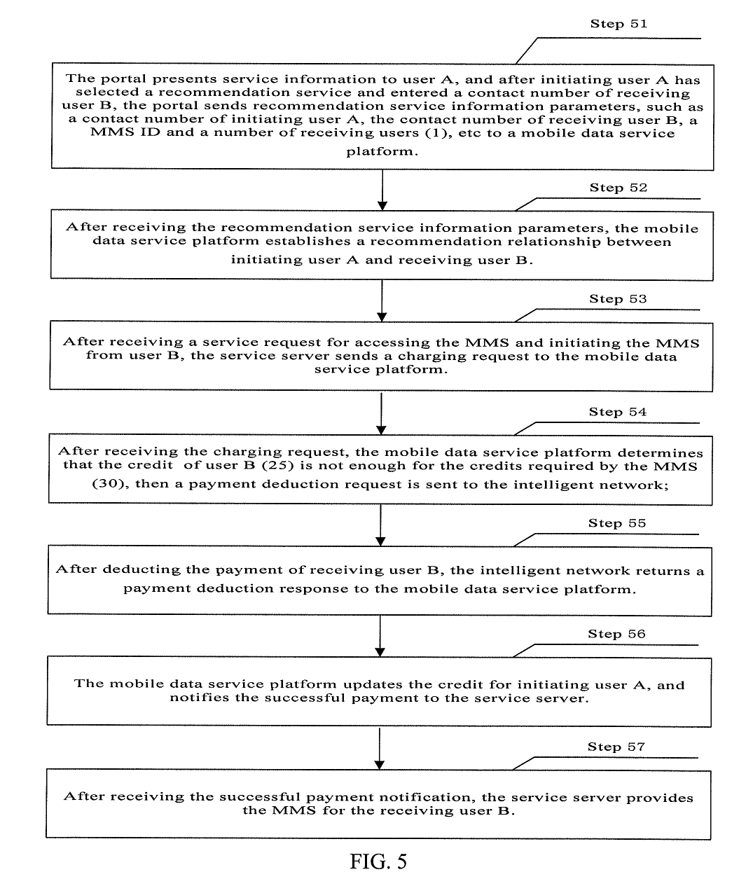

In this embodiment, an example will be described in which initiating user A recommends a MMS to receiving user B, the payment deduction device is an intelligent network, user B has 25 credit sufficient for the MMS requiring 30 credits, particularly as shown in FIG. 5.

Step 51. The portal presents service information to user A, and after initiating user A has selected a recommendation service and inputted a contact number of receiving user B, the portal sends recommendation service information parameters, such as a contact number of initiating user A, the contact number of receiving user B, a MMS ID and a number of receiving users (1), etc, to a mobile data service platform.

Step 52. After receiving the recommendation service information parameters, the mobile data service platform establishes a recommendation relationship between initiating user A and receiving user B.

Step 53. After receiving a service request for accessing the MMS and initiating the MMS from user B, the service server sends a charging request to the mobile data service platform.

Step 54. After receiving the charging request, the mobile data service platform determines that the credit of user B (25) is not enough for the credit required by the MMS (30), then a payment deduction request is sent to the intelligent network; if user B has sufficient credit for that required by the MMS (30), the mobile data service platform deducts corresponding credit of user B and the process proceeds to step 56.

Step 55. After deducting the payment of receiving user B, the intelligent network returns a payment deduction response to the mobile data service platform.

Step 56. The mobile data service platform updates credit for initiating user A, and notifies the successful payment to the service server.

Step 57. After receiving the successful payment notification, the service server provides the MMS to the receiving user B.

In this embodiment, if initiating user A provides as a gift a MMS to receiving user B, a gift relationship between user A and user B is established at step 52. At step 54, it is determined whether user A has sufficient credit for the gift MMS. Credit or a payment amount of user A is correspondingly deducted, and more credit may be increased for initiating user A compared to the case of recommendation services.

Those skilled in the art may understand that some or all steps of the method of the above described embodiment can be realized with programs and instruction related hardware, the programs can be stored in a computer readable storage medium, such as, a magnetic disk, an optical disc, ROM (Read-Only Memory)/RAM (Random Access Memory), etc, which when executed include steps of the method of the embodiment.

In the embodiment of this invention, an initiating user recommends or provides as a gift service information to a receiving user through a mobile data service platform or a carrier portal, and the process of inputting information of initiating users of recommendation and gift before using service information by receiving users is omitted, enabling more accurate recommendation or gift relationship and real-time updating of user credits, which is convenient for initiating users and can improve user experience. At the same time, users can pay on the mobile data service platform by credit or pay from their accounts without the need of releasing a credit redeeming service by the carrier. Therefore, users can decide by themselves to pay for right services without the restriction of credit redeeming for merely services recommendation by carriers, which is convenient for initiating users and can improve user experience. User credits/the number of recommendations or gifts can be saved and accumulated in real time on the mobile data service platform, making the mobile data service platform more powerful, and improving the efficiency of processing recommendation or gift services by the service data platform.

Description above is merely particular implementations of this invention, and the scope of this invention is not limited thereto. Any those skilled in the art can easily conceive modifications or alternations within the technical scope disclosed in this invention, which should be covered in the scope of this invention. Thus, the scope of this invention should coincide with the scope of accompanying claims.

1. A method for providing value-added service, in comprising:
receiving a recommendation or gift service information parameter transmitted from a carrier portal, establishing a recommendation or gift relationship according to the recommendation or gift service information parameter and notifying the recommendation or gift service information parameter to a receiving user of the recommendation or gift service;
receiving a charging request sent by a service server after the service server receives a request of the recommendation or gift service from the receiving user;
charging for the recommendation or gift service initiated by the receiving user according to the credit of a paying user;
updating the credit of a initiating user of the recommendation or gift service according to the established recommendation or gift relationship after successful charging.

2. The method according to claim 1, wherein the recommendation or gift service information parameter comprises initiating user information, receiving user information, and a recommendation or gift service information ID.

3. The method according to claim 2, wherein charging for the recommendation or gift service initiated by the receiving user according to the credit of a paying user comprises:
determining whether a paying user has enough credit to pay a number required by the recommendation or gift service initiated by the receiving user, if enough, deducting the corresponding number from the credit of the paying user, otherwise, keeping the credit unchanged and charging an account of the paying user.

4. The method according to claim 1, wherein updating the credit of the initiating user comprise increasing the credit of the initiating user, wherein the number of increased credit is the product of the number of a receiving user and a service reward coefficient set up by the carrier, including a recommendation service reward coefficient or a gift service rewarded coefficient.

5. A data service platform for providing value-added services, comprising:
a receiving module, for receiving recommendation or gift service information parameter transmitted from a carrier portal,
an establishing module, for establishing a recommendation or gift relationship according to the recommendation or gift service information parameter received by the receiving module and notifying the recommendation or gift service information parameter to a receiving user of the recommendation or gift service; wherein,
the receiving module is further adapted to receive a charging request sent by a service server after the service server receives a request of the recommendation or gift service from the receiving user;
a charging module, for charging for the recommendation or gift service initiated by the receiving user according to the credit of a paying user;
an updating module, for updating the credit of the initiating user after successful charging according to the recommendation or gift relationship established by the establishing module.

6. The data service platform according to claim 5, wherein the recommendation or gift service information parameter in the receiving module comprises initiating user information, receiving user information, and a recommendation or gift service information ID.

7. The data service platform according to claim 5 wherein the charging module is adapted to determine whether a paying user has enough credit to pay a number required by the recommendation or gift service initiated by the receiving user, if enough, deduct the corresponding number from the credit of the paying user, otherwise, keep the credit unchanged and charge an account of the paying user.

8. The data service platform according to claim the updating module is adapted to increase the credit of the initiating user, wherein the number of increased credit is the product of the number of receiving users and a service reward coefficient set up by the carrier, including a recommendation service reward coefficient or a gift service rewarded coefficient.

9. A system for providing value-added services, comprising a mobile data service platform, a carrier portal, a service server and a payment deducting device, wherein,
the portal is adapted to present service information to a user, and send a recommendation or gift service information parameter to a mobile data service platform, the recommendation or gift service information parameter comprising initiating user information, receiving user information, and a recommendation or gift service information ID;
the mobile data service platform is adapted to establish a recommendation or gift relationship according to the received recommendation or gift service information parameter sent from the carrier portal; after receiving the charging request sent by the service server, determine whether a paying user has enough credit to pay for the recommendation or gift service initiated by the receiving user, if enough, deduct a corresponding number of credit of the paying user, otherwise send a payment deduction request to the payment deducting device; update the credit of the initiating user after deducting the corresponding number from the credit of the paying user or receiving the payment deduction response information sent by the payment deducting device, and notify the successful payment to the service server;
the payment deducting device is adapted to receive the payment deduction request, and return a payment deduction response to the mobile data service platform after deducting a payment from the paying user;
the service server is adapted to send a charging request to the mobile data service platform after receiving a request of the recommendation or gift service from the receiving user, and provide the recommendation or gift service for the receiving user after receiving the notification of the successful payment from the mobile data service platform.
